(19) United States
(12) Patent Application Publication
(10) Pub. No.: US 2010/0063879 A1
(43) Pub. Date: Mar. 11, 2010

(54) Systems and Methods to Selectively Provide Information Based on User Interest

(75) Inventors: Araz ARARADIAN, Glendale, CA (US); Kotcherlakota BAPA RAO, Los Angeles, CA (US)

Correspondence Address: AT&T Legal Department - GT;Attn: Patent Docketing, Room 2A-207, One AT&T Way, Bedminster, NJ, 07921, US

(73) Assignee: YELLOWPAGES.COM LLC, Glendale, CA (US)

(21) Appl. No.: 12/205,459

(22) Filed: Sep. 5, 2008

(51) Int. Cl. G06Q 30/00

(52) U.S. Cl. 705/14.53

(57) ABSTRACT

Systems and methods are provided to advertise based on the postings of a user. For example, after receiving a posting from a first user, a web site may present the posting to a plurality of second users. A content analyzer identifies at least one topic based at least in part on the posting to select an advertisement. An electronic messaging system then delivers the advertisement to the first user and/or the second users.

### FIELD OF THE TECHNOLOGY

At least some embodiments disclosed herein relate to information communications in general and, particularly but not limited to, selecting and providing information, such as advertisements, based on user interest.

### BACKGROUND

Internet provides a versatile communication channel through which people may receive information and/or communicate with each other. For example, web users may communicate with each other via web sites.

For example, web sites can be used to register the social connections of members of a social network, which represents a social structure where a network of nodes can be used to represent a network of individuals or organizations and the connections between the nodes in the network can be used to represent the direct social connections.

Social network web sites may provide features such as automatic address book updates, viewable profiles, services to introduce members to each other to make new social connections, messaging systems for communicating with other members, etc. Some social network web sites are organized around business connections; and some social network web sites are organized around common interests.

Using a web site, people may chronologically publish personal thoughts and web links. Such a web site may be referred to as a blog. A blog may include content showing what is happening in the life of the person, collecting information on certain types of subjects of interest to the person, providing links to related web sites, etc. A personal web site may include a collection of contents that may be helpful to people of similar interest.

In general, a web user may provide a posting for viewing by other users. A posting may be an online message placed in a blog, a newsgroup, bulletin board system, or some other public discussion group.

In some social network web sites, a member of the social network may provide postings (e.g., in a web site, such as a blog site) for viewing by other members of the social network. The social network may allow the public to view the posting, or limit the access to the postings to the friends of the member in the social network.

### BRIEF DESCRIPTION OF THE DRAWINGS

The embodiments are illustrated by way of example and not limitation in the figures of the accompanying drawings in which like references indicate similar elements.

FIG. 1 shows a system to select and deliver advertisements according to one embodiment.

FIG. 2 shows a system to present business listings and advertisements according to one embodiment.

FIG. 3 shows a method to provide advertisements according to one embodiment.

FIG. 4 shows a method to present a listing and collect information about the listing according to according to one embodiment.

FIG. 5 illustrates a data processing system which can be used in various embodiments.

### DETAILED DESCRIPTION

The following description and drawings are illustrative and are not to be construed as limiting. Numerous specific details are described to provide a thorough understanding. However, in certain instances, well known or conventional details are not described in order to avoid obscuring the description. References to “one embodiment” or “an embodiment” in the present disclosure are not necessarily references to the same embodiment; and, such references mean at least one.

Reference in this specification to “one embodiment” or “an embodiment” means that a particular feature, structure, or characteristic described in connection with the embodiment is included in at least one embodiment of the disclosure. The appearances of the phrase “in one embodiment” in various places in the specification are not necessarily all referring to the same embodiment, nor are separate or alternative embodiments mutually exclusive of other embodiments. Moreover, various features are described which may be exhibited by some embodiments and not by others. Similarly, various requirements are described which may be requirements for some embodiments but not other embodiments.

The present disclosure provides systems and methods to advertise based on the postings of a user. For example, after receiving a posting from a first user, a web site may present the posting to a plurality of second users. A content analyzer identifies at least one topic based, at least in part, on the posting to select an advertisement. An electronic messaging system then delivers the advertisement to the first user and/or the second users. The disclosure includes methods and apparatuses which perform these methods, including data processing systems which perform these methods, and computer readable media containing instructions which when executed on data processing systems cause the systems to perform these methods.

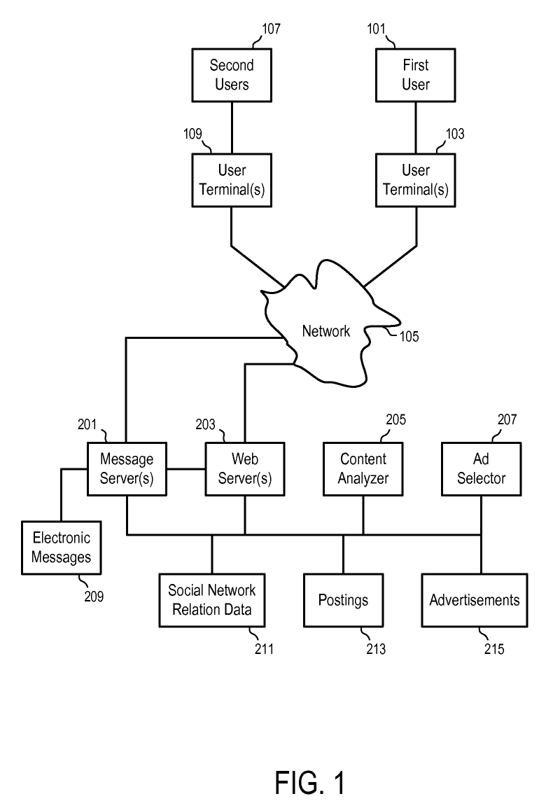

FIG. 1 shows a system to select and deliver advertisements according to one embodiment.

In FIG. 1, a first end user (101) may use a user terminal (103) to submit a posting (213) over the network (105) to a web server (203). The network (105) may include a local area network, a wireless data communication network, a telephone network, a cellular communication network, a telecommunication network, an interactive television network, an Internet Protocol Television (IPTV) network, an intranet, or a combination of networks, such as Internet.

In FIG. 1, the web server (203) maintains the posting (213) at a web site. The second users (107) can assess the web site via the user terminals (109), network (105) and the web server (203). The web server (203) may provide the posting (213) to the user terminals via HyperText Transfer Protocol (HTTP) and/or other types of communication protocols, such as File Transfer Protocol (FTP), Wireless Application Protocol (WAP), etc. The web server (203) may provide static web pages, dynamic web pages, and/or web services.

In one embodiment, the first user (101) and the second users (107) are members of a social network; and the social network relation data (211) indicates the social connections between the first user (101) and the second users (107).

In one embodiment, the web server (203) restricts the access to the posting (213) of the first user (101) to the second users (107) who have direct social connections with the first user (101), according to the social network relation data (211). In some embodiments, the web server (203) restricts the access to the posting (213) of the first user (101) to the second users (107) who are within a threshold distance from the first user (101), according to the social network relation data (211). In some embodiments, the web server (203) may also allow the public to access the posting (213) of the first user.

In some embodiments, the web server (203) provides web applications to the user terminals (e.g., 103 or 109) for execution in a web browser running on the user terminal (e.g., 103 or 109); and the web applications may include scripts, such as Java, JavaScript, etc., for execution within an isolated environment in a browser.

In some embodiments, the web server (203) may provide rich-client applications to the user terminal (e.g., 103 or 109); and the rich-client application may be programmed in traditional programming languages, such as C/C++, to have full access to functions of the operating system running on the user terminal (e.g., 103 or 109).

The web server (203) may communicate with a content analyzer (205), an advertisement selector (207), and/or a message server (201) to process the posting (213) and provide a selected advertisement (215) to the first user (101) and/or the second users (107) via electronic messages (209).

In one embodiment, the content analyzer (205) determines a topic of interest to the first user (101) based on the posting (213) of the first user (101). For example, the posting (213) of the first user (101) may be related to a product, a service, or a brand name, etc. For example, the postings (213) of the first user (101) may be blog entries of the first user (101). The first user (101) may maintain the blog to discuss products and/or services of personal interest to the first user (101). The content analyzer (205) identifies the products and/or services of personal interest to the first user (101) based on the content of the postings (213) of the first user (101).

Based on the topic of interest to the first user (101), the advertisement selector (207) selects a relevant advertisement (215) that is likely of interest to the first user (101) and generates a message (209) to deliver the advertisement (215) to the first user (101) via the message server (201).

In one embodiment, the message server (201) is distinct and separate from the web server (203) for presenting the posting (213) of the first user (101). For example, the message server (201) can be an electronic mail server, or a server for short message service (SMS) or multimedia messaging service (MMS) message. In some embodiments, the message server (201) may send the electronic message (209) via an instant messaging system.

In one embodiment, the message server (201) may include a web server to provide the electronic messages (209) via a web site. For example, the message server (201) may present the electronic messages (209) as web mails. In one embodiment, both the message server (201) and the web server (203) are part of an online social network site; and the message server (201) and the web server (203) may share hardware components. In some embodiments, the message servers (201) are also web servers.

In one embodiment, the advertisement selector (207) also selects the advertisement (215) for the second users (107) according to the posting (213) of the first user (101). The advertisement selector (207) also identifies the second users (107) based on the social network relation data (211). For example, advertisement selector (207) can generate the electronic message (209) to transmit the advertisement (215) to the second users (107) who are directly connected to the first user (101) according to the social network relation data (211), or the second users (107) who are within a predetermined social distance from the first user (101) according to the social network relation data (211).

In one embodiment, after the advertisement selector (207) selects the advertisement (215) based on the topic identified by the content analyzer (205), the message server (201) transmits the electronic message (209) to deliver the advertisement (215) to the second users (107). The second users (107) may or may not view the posting (213).

In another embodiment, the message server (201) transmits the electronic message (209) to deliver the advertisement (215) to the second users (107) in response to the second users (107) viewing the posting (213), or in response to the second users (107) provide comments on the posting (213).

In a further embodiment, the web server (203) presents the posting (213) together with the advertisement (215) to the second users (107), when the second users (107) visit the site of the posting (213).

In one embodiment, the advertisement selector (207) selects not only advertisements (215) but also other information that relate to the topic identified by the content analyzer (205). For example, the advertisement selector (207) may select web pages or postings (213) by other users that are related to the topic and provide the selected web pages or postings (213) to the first user (101) and/or the second users (107) via the message server (201).

In one embodiment, the message servers (201), the web servers (203), the content analyzer (205) and/or the advertisement selector (207) are servers communicating with each other over a network, such as a local area network, an intranet, or Internet. These servers may run on same or separate computers.

In one embodiment, there may be one or more layers of application servers between the web server (203) and one or more data storage facilities that store the postings (213), the advertisements (215), the social network relation data (211) and/or the electronic messages (209). The application servers processes the business logic and facilitate data access (e.g., for rich-client applications, or for dynamic web pages). Alternatively, application servers may be integrated with the web servers (203). Thus, the disclosure is not limited to particular types of connections among the servers (e.g., 201, 203, 205, and 207).

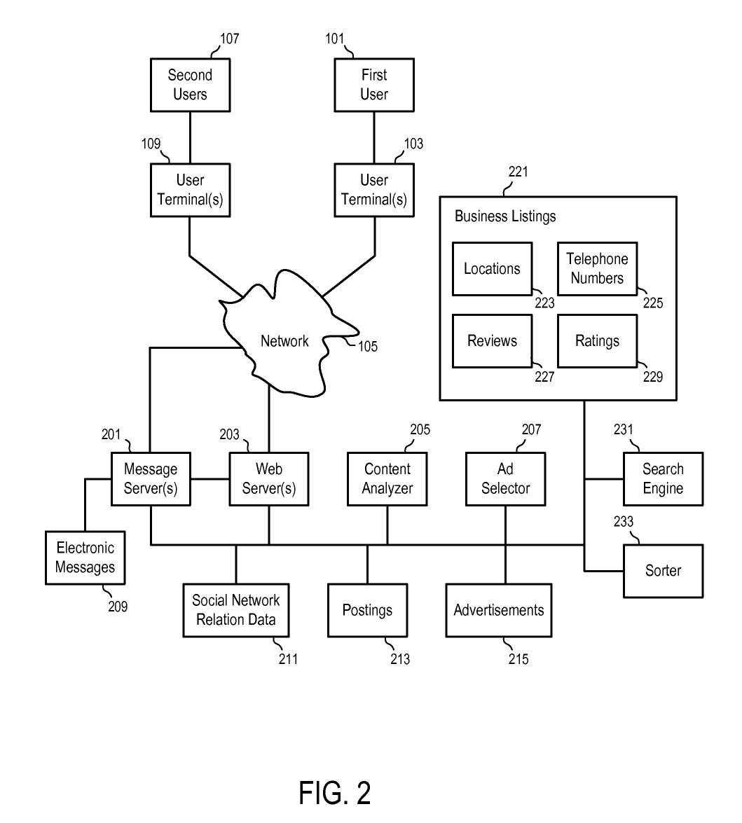

FIG. 2 shows a system to present business listings and advertisements according to one embodiment. In FIG. 2, the web servers (203) may also present a business listing (221) to the second users (107) together with the posting (213) of the first user (101).

In one embodiment, the listings (221) of businesses, such as restaurants, car dealers, retailers, service providers, gas stations, parking lots, plumbers, and the like, provides the locations (223) of the businesses and/or the telephone numbers (225) of the businesses. The locations (223) may be street addresses or other location parameters, such as longitude and latitude coordinates. The listings (221) may further include other information about the businesses, such as reviews (227), ratings (229), etc. In one embodiment, the listings (e.g., 221) are information related to business entities at corresponding geographic locations (223).

In some embodiments, at least one of the web servers (203) provides listings (221) as a directory service; and an end user (e.g., 101 or 107) can search for particular types of listings (221) via the search engine (231). The sorter (233) prioritized the search results of the search engine (231) for presentation. For example, the sorter (233) may order the search results based on the distances between the locations (223) and a location of interest to the search requester. For example, the sorter (233) may order the search results based on the popularity of the listings (221), and/or based on advertisement fees.

In one embodiment, the web server (203) provides listings (221) as advertisements, together with other types of information, such as postings (213), blog entries, publications, news articles, review articles, etc.

In one embodiment, some of the entities may be advertisers who pay advertisement fees to promote their listings (221). Some of the entities may be non-advertisers who have free listings (221).

In one embodiment, the first user (101) may provide a posting (213) related to a listing (221); and the web server (203) provides a user interface to present the listing (221). Through the user interface, the second users (107) can view the listing (221), including an indication of the rating (229) and the review (227) of the business listing (221), while the second users (107) visit the posting (213). In one embodiment, the indication of the rating (229) includes an average of prior ratings (229) received from various users (e.g., 101, 107).

In one embodiment, the user interface further allows the second users (107) to provide their ratings (229), reviews (227) and/or other information about the listing (221), such as comments, recommendations, experiences, etc.

In one embodiment, the first user (101) may select the listing (221) for presentation with the posting (213). In another embodiment, the advertisement selector (207) selects the listing (221) based on the topic identified by the content analyzer (205), which identifies the topic based on the content of the posting (213).

In one embodiment, the first user (101) may be associated with the listing (221). When the first user (101) opens an account to advertise or promote the listing (221), the first user (101) is provided with a code that implements the user interface presenting the listing (221) with the posting (213).

In one embodiment, the operator of the social network web server (203) for presenting the postings (213) is different from the operator of the business listings (221). The code that implements the user interface allows the first user (101) to present the listing (221) via the social network web server (203) and to collect user input about the listing (221), such as collecting user ratings (229) and reviews (227) from the second users (107) who visit the posting (213) of the first user (101).

In another embodiment, the business listings (221) are part of the social network site.

In one embodiment, the web server (203) or the advertisement selector (207) presents the ratings (229) and the reviews (227) of the listing (221) based on the social network relation data. For example, when the access to the posting (213) of the first user (101) is limited to a set of second users (107) based on the social network relation data (211), the selection of the ratings (229) and the reviews (227) is also limited to the same set of second users (107). For example, if the access to the posting (213) of the first user (101) is limited to the second users (107) who have direct social connections with the first user (101) (or within a predetermined social distance from the first user (101), the average rating presented by the web server (203) to the second users (107) is based on the ratings (229) provided by one or more of the second users (107), excluding the ratings (229) provided by others who are not allowed to access the posting (213) of the first user (101); and the web server (203) may limit the presentation of the reviews (227) to a sub set of reviews (227) by those who have access to the posting (213) of the first user (101).

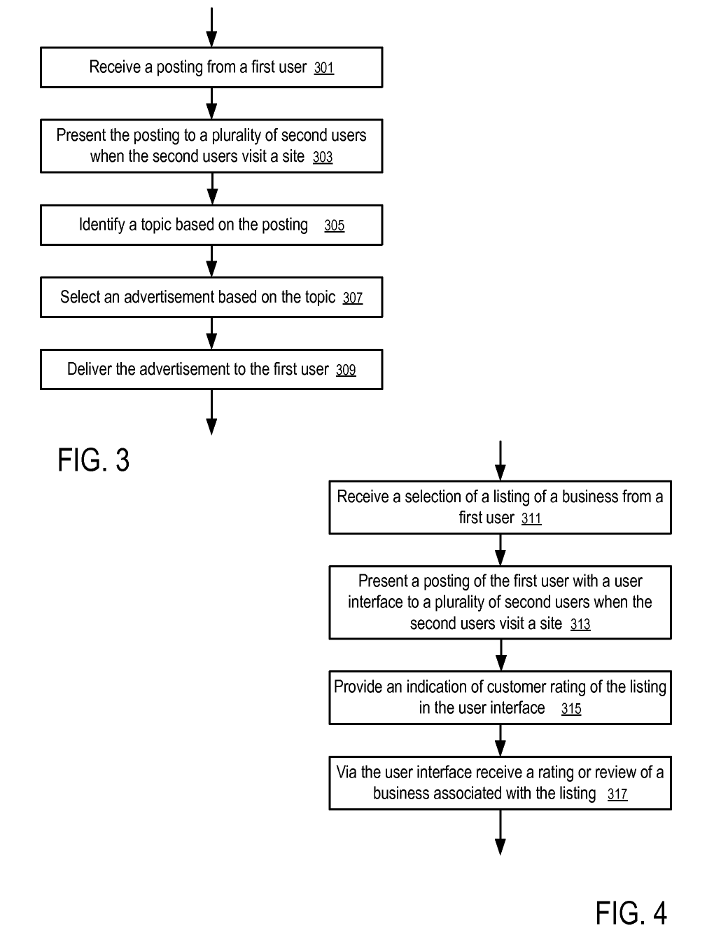

FIG. 3 shows a method to provide advertisements according to one embodiment. In FIG. 3, after a web server (203) receives (301) a posting (213) from a first user (101), the web server (203) present (303) the posting (213) to a plurality of second users (107) when the second users visit a site of the posting (213). A content analyzer (205) identifies (305) a topic based on the posting (213); and an advertisement selector select (307) an advertisement (215) based on the topic. The message server (201) delivers the advertisement (215) to the first user (101) using an electronic message (209)

In one embodiment, the electronic message (209) includes the advertisement (215). In another embodiment, the electronic message (209) includes a link to the advertisement (215).

When the link is selected by the first user (101), the web server (203) presents the advertisement (215).

In one embodiment, a message server (201) of an electronic messaging system which is separate from the site hosting on the web server (203) delivers the advertisement (215) to the first user (101). In one embodiment, the messaging server (201) or the web server (203) delivers the advertisement (215) to one or more of the second users (107) in response to the second users (107) visiting the site of the first user (101). In one embodiment, the web server (203) presents the advertisement (215) to one or more of the second users (107) on the site of the first user (213) (e.g., the blog site of the first user (213)) while presenting the posting (213) of the first user (101).

In one embodiment, the topic identified by the content analyzer (205) is a product or service discussed in the posting (213); and the advertisement (215) is about the product or service.

In one embodiment, the topic identified by the content analyzer (205) is a band name discussed in the posting (213); and the advertisement (215) is about a product or service having the brand name.

FIG. 4 shows a method to present a listing and collect information about the listing according to according to one embodiment. In FIG. 4, after the web server (203) receives (311) a selection of a listing (221) of a business from a first user, the web server (203) (or another server not shown in FIG. 2) associates the listing (221) with a posting (213) of the first user (101). The web server (203) presents (313) the posting (213) of the first user with a user interface to a plurality of second users (107) when the second users (107) visit a site of the posting (213). The user interface provides (315) an indication of customer rating (229) of the listing (221). Via the user interface, the web server (203) receive (317) a rating, comment, or review for a business associated with the listing (221) from the second users (217).

In one embodiment, the business listing (221) provides information about the business, including contact information such as a telephonic reference which a user can used on a communication network to establish a telephonic connection with a representative of the business.

In one embodiment, the web server (203) may receive comments on the posting (213) from the second users (107). The content analyzer (205) and the advertisement selector (207) may select one or more advertisements (215) based on the posting (213) and the comments. The message servers (201) or the web server (203) then deliver the one or more selected advertisements to the second users (107) in response to the comments.

In one embodiment, a user terminal (e.g., 103 or 109) is a data processing system, such as a notebook computer, a personal computer, a workstation, a network computer, a personal digital assistant (PDA), a mobile phone, a cellular phone, a landline phone, a television set with or without a set top box, a game console, an electronic kiosk, microprocessor-based or programmable consumer electronics, and the like.

In one embodiment, one computer system implements the web servers (203), the content analyzer (205), the advertisement selector (207), the message servers (201), the search engine (231) and/or the sorter (233). Alternatively, different processes running on one or more shared computers may implement some of the components (201, 203, 205, 207, 231, and 233). For example, one computing module, thread, or process may implement multiple of the components (201, 203, 205, 207, 231, and 233). In some embodiments, special purpose data processing systems implement the one or more of the components (201, 203, 205, 207, 231, and 233), such as using Application-Specific Integrated Circuit (ASIC) or Field-Programmable Gate Array (FPGA). In some embodiments, processes running according to software instructions on general purpose data processing systems, such as general purpose personal computers or server computers, can implement the server components (201, 203, 205, 207, 231, and 233). Thus, the implementations are not limited to hardware, software, or particular combinations of hardware and software.

Different embodiments may implement the data storage facility in different ways to store the postings (213), the advertisements (215), the social network relation data (211), the electronic messages (209), and/or the business listings (221). For example, the data storage facility may include one or more relational or object oriented databases, or flat files on one or more computers or networked storage devices, etc. The data storage facility may be a centralized system, or include a distributed system, such as a peer to peer network, or Internet.

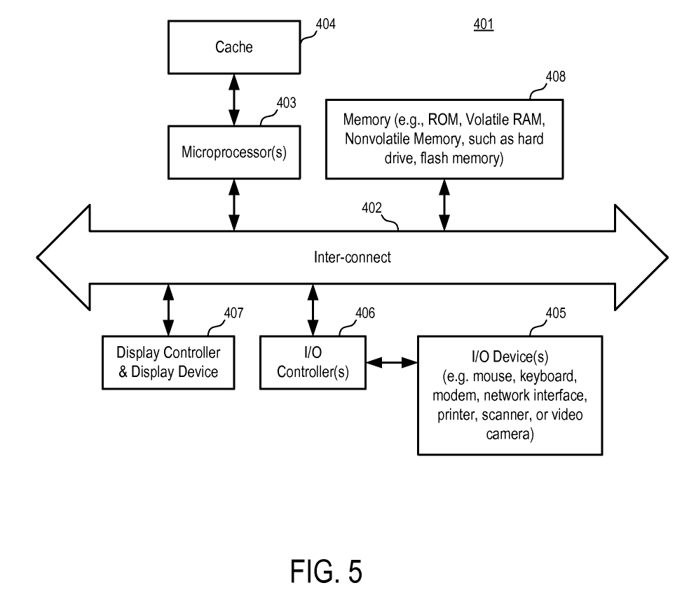

FIG. 5 illustrates a data processing system which can be used in various embodiments. While FIG. 5 illustrates various components of a computer system, it is not intended to represent any particular architecture or manner of interconnecting the components. Some embodiments may use other systems that have fewer or more components than those shown in FIG. 5.

In one embodiment, a server data processing system illustrated in FIG. 5 implements at least one of the components shown in FIG. 1 or FIG. 2, such as the web server(s) (203), the content analyzer (205), the advertisement selector (207), the message server (201), the search engine (231), the sorter (233), and/or the storage facility to store the social network relation data (211), the posting (213), the advertisements (215), the electronic messages (209), and/or the business listings (221), etc.

In some embodiments, one or more of the components shown in FIG. 1 or FIG. 2, such as the web server(s) (203), the content analyzer (205), the advertisement selector (207), the message server (201), the search engine (231), the sorter (233), and/or the storage facility to store the social network relation data (211), the posting (213), the advertisements (215), the electronic messages (209), and/or the business listings (221), etc. may include the service of a peer to peer network of a plurality of data processing systems as illustrated in FIG. 5, or a network of distributed computing systems. In some embodiments, a server data processing system as illustrated in FIG. 5 may include a peer to peer network, or a distributed computing system.

In one embodiment, a user terminal (e.g., 103 or 109) is a data processing system as illustrated in FIG. 5.

In FIG. 5, the data processing system (401) includes an inter-connect (402) (e.g., bus and system core logic), which interconnects a microprocessor(s) (403) and memory (408). The microprocessor (403) is coupled to cache memory (404) in the example of FIG. 5.

The inter-connect (402) interconnects the microprocessor(s) (403) and the memory (408) together and also interconnects them to a display controller and display device (407) and to peripheral devices such as input/output (I/O) devices (405) through an input/output controller(s) (406). Typical I/O devices include mice, keyboards, modems, network interfaces, printers, scanners, video cameras and other devices which are well known in the art. In some embodiments, when the data processing system is a server system, some of the I/O devices, such as printer, scanner, mice, and/or keyboards, are optional.

The inter-connect (402) may include one or more buses connected to one another through various bridges, controllers and/or adapters. In one embodiment the I/O controller (406) includes a USB (Universal Serial Bus) adapter for controlling USB peripherals, and/or an IEEE-1394 bus adapter for controlling IEEE-1394 peripherals.

The memory (408) may include ROM (Read Only Memory), volatile RAM (Random Access Memory), and non-volatile memory, such as hard drive, flash memory, etc.

Volatile RAM is typically implemented as dynamic RAM (DRAM) which requires power continually in order to refresh or maintain the data in the memory. Non-volatile memory is typically a magnetic hard drive, a magnetic optical drive, an optical drive (e.g., a DVD RAM), or other type of memory system which maintains data even after power is removed from the system. The non-volatile memory may also be a random access memory.

The non-volatile memory can be a local device coupled directly to the rest of the components in the data processing system. A non-volatile memory that is remote from the system, such as a network storage device coupled to the data processing system through a network interface such as a modem or Ethernet interface, can also be used.

In this description, various functions and operations may be described as being performed by or caused by software code to simplify description. However, those skilled in the art will recognize that what is meant by such expressions is that the functions result from execution of the code/instructions by a processor, such as a microprocessor. Alternatively, or in combination, the functions and operations can be implemented using special purpose circuitry, with or without software instructions, such as using Application-Specific Integrated Circuit (ASIC) or Field-Programmable Gate Array (FPGA). Embodiments can be implemented using hardwired circuitry without software instructions, or in combination with software instructions. Thus, the techniques are limited neither to any specific combination of hardware circuitry and software, nor to any particular source for the instructions executed by the data processing system.

While some embodiments can be implemented in fully functioning computers and computer systems, various embodiments are capable of being distributed as a computing product in a variety of forms and are capable of being applied regardless of the particular type of machine or computer-readable media used to actually effect the distribution.

At least some aspects disclosed can be embodied, at least in part, in software. That is, the techniques may be carried out in a computer system or other data processing system in response to its processor, such as a microprocessor, executing sequences of instructions contained in a memory, such as ROM, volatile RAM, non-volatile memory, cache or a remote storage device.

Routines executed to implement the embodiments may be implemented as part of an operating system or a specific application, component, program, object, module or sequence of instructions referred to as “computer programs”. The computer programs typically include one or more instructions set at various times in various memory and storage devices in a computer, and that, when read and executed by one or more processors in a computer, cause the computer to perform operations necessary to execute elements involving the various aspects.

A machine readable medium can be used to store software and data which when executed by a data processing system causes the system to perform various methods. The executable software and data may be stored in various places including for example ROM, volatile RAM, non-volatile memory and/or cache. Portions of this software and/or data may be stored in any one of these storage devices. Further, the data and instructions can be obtained from centralized servers or peer to peer networks. Different portions of the data and instructions can be obtained from different centralized servers and/or peer to peer networks at different times and in different communication sessions or in a same communication session. The data and instructions can be obtained in entirety prior to the execution of the applications. Alternatively, portions of the data and instructions can be obtained dynamically, just in time, when needed for execution. Thus, it is not required that the data and instructions be on a machine readable medium in entirety at a particular instance of time.

Examples of computer-readable media include but are not limited to recordable and non-recordable type media such as volatile and non-volatile memory devices, read only memory (ROM), random access memory (RAM), flash memory devices, floppy and other removable disks, magnetic disk storage media, optical storage media (e.g., Compact Disk Read-Only Memory (CD ROMS), Digital Versatile Disks (DVDs), etc.), among others. The instructions may be embodied in digital and analog communication links for electrical, optical, acoustical or other forms of propagated signals, such as carrier waves, infrared signals, digital signals, etc.

In general, a machine readable medium includes any mechanism that provides (i.e., stores and/or transmits) information in a form accessible by a machine (e.g., a computer, network device, personal digital assistant, manufacturing tool, any device with a set of one or more processors, etc.).

In various embodiments, hardwired circuitry may be used in combination with software instructions to implement the techniques. Thus, the techniques are neither limited to any specific combination of hardware circuitry and software nor to any particular source for the instructions executed by the data processing system.

Although some of the drawings illustrate a number of operations in a particular order, operations which are not order dependent may be reordered and other operations may be combined or broken out. While some reordering or other groupings are specifically mentioned, others will be apparent to those of ordinary skill in the art and so do not present an exhaustive list of alternatives. Moreover, it should be recognized that the stages could be implemented in hardware, firmware, software or any combination thereof.

In the foregoing specification, the disclosure has been described with reference to specific exemplary embodiments thereof. It will be evident that various modifications may be made thereto without departing from the broader spirit and scope as set forth in the following claims. The specification and drawings are, accordingly, to be regarded in an illustrative sense rather than a restrictive sense.

What is claimed is:

1. A method implemented in a data processing system, the method comprising:
receiving in the data processing system a posting from a first user;
presenting the posting of the first user to a plurality of second users of the data processing system when the second users visit a site of the first user;
identifying at least one topic based at least in part on the posting;
selecting an advertisement based on the topic; and
delivering the advertisement to the first user.

2. The method of claim 1, wherein the advertisement is delivered to the first user via an electronic messaging system separate from the site.

3. The method of claim 1, further comprising:
delivering the advertisement to one or more of the second users in response to the second users visiting the site of the first user.

4. The method of claim 3, wherein the advertisement is delivered to the one or more of the second users via an electronic messaging system separate from the site.

5. The method of claim 1, further comprising:
presenting the advertisement to one or more of the second users on the site of the first user while presenting the posting of the first user.

6. The method of claim 1, wherein the topic is a product discussed in the posting; and the advertisement is about the product.

7. The method of claim 1, wherein the topic is a service discussed in the posting; and the advertisement is about the service.

8. The method of claim 1, wherein the topic is a band name discussed in the posting; and the advertisement is about a product or service of the brand name.

9. The method of claim 1, wherein the posting comprises an entry of a web log of the user.

10. The method of claim 1, further comprising:
storing on the data processing system data that represents a social network;
wherein the first user and the second users are members of the social network; and
the second users are directly connected to the first user in the social network.

11. The method of claim 10, further comprising:
identifying the second users based on the data that represents the social network; and
providing the advertisement to the second users identified based on the data that represents the social network.

12. The method of claim 10, further comprising:
providing a user interface together with the posting to the second users, the user interface to present a business listing selected by the first user and an indication of customer rating for the business listing.

13. The method of claim 12, wherein the user interface includes user interface elements to receive a rating for the business listing for a user of the user interface.

14. The method of claim 12, wherein the user interface includes a user interface element to receive a review or comment for the business listing for a user of the user interface.

15. The method of claim 12, wherein the user interface includes a user interface element to receive a review for the business listing for a user of the user interface.

16. The method of claim 12, wherein the business listing includes at least a telephonic reference.

17. The method of claim 16, further comprising:
providing a set of instructions to implement the user interface in the data processing systems to a business of the listing.

18. The method of claim 1, further comprising:
receiving from the second users comments on the posting;
selecting one or more advertisements based on the posting and the comments; and
delivering the one or more advertisements to the second users in response to the comments.

19. A machine readable media embodying instructions, the instructions causing a data processing system to perform a method, the method comprising:
receiving in the data processing system a posting from a first user;
presenting the posting of the first user to a plurality of second users of the data processing system when the second users visit a site of the first user;
identifying at least one topic based at least in part on the posting;
selecting an advertisement based on the topic; and
delivering the advertisement to the first user.

20. A data processing system, comprising:
receiving in the data processing system a posting from a first user;
presenting the posting of the first user to a plurality of second users of the data processing system when the second users visit a site of the first user;
identifying at least one topic based at least in part on the posting;
selecting an advertisement based on the topic; and
delivering the advertisement to the first user.
